(19) United States
(12) Patent Application Publication
(10) Pub. No.: US 2022/0395429 A1
(43) Pub. Date: Dec. 15, 2022

(54) NOVEL DRY NEEDLING SYSTEM ANDTECHNIQUE FOR DIRECT CONNECT TISSUE FASCIA RELEASE

(71) Applicant: Zhixin Wang, Tampa, FL (US)

(72) Inventor: Zhixin Wang, Tampa, FL (US)

(21) Appl. No.: 17/344,930

(22) Filed: Jun. 10, 2021

(51) Int. Cl. A61H 39/08; A61H 39/00

(52) U.S. Cl. CPC A61H 39/08; A61H 39/007; A61H 2201/1261; A61H 2201/0214

(57) ABSTRACT

A system and method for direct connect tissue fascia with a thin filiform needle piercing the skin, going underneath the skin into connective tissue fascia layer, to directly manipulate (stretch and vibrate) connective tissue fascia to reduce fascia adhesion/restriction and achieve efficient fascia release outcome.

### FIELD OF THE DISCLOSURE

This disclosure relates generally to the field of fascia restriction releasing techniques and more particularly a system and method for achieving myofascial adhesion release in a patient via filiform needle directly manipulating the restricted fascia connective tissue.

### BACKGROUND

As advanced anatomy myofascial research emerges, the functions and properties of connective tissue fascial layers have drawn attention in clinical service. The fascia is a band or sheet of connective tissue, made up of collagen fibers, elastin fibers, cells (include adipose cells, eosinophil, fibroblast, mast cells, lymphocytes et al), sponge-like mucous ground substance composed of mucopolysaccharides such as hyaluronan, chondroitin, keratin, laminin, fibronectin, heparin, and water, as well as abundant nerves and capillaries. This whole continuous fascia connective tissue extends all over a human body, underneath the skin, surrounding muscles, bones, and viscerals. It provides structure, shock absorption, and movements.

Inventor has a background of Material/Mechanical Engineering, and has researched the effects of soft biomaterials' mechanical properties on cellular activities. Skin (includes multiple layers), connective tissue fascia, adipose tissue, nerves, muscles, bones . . . all have different mechanical properties, which means they have different elasticity, stiffness, and viscosity. As we age, fascia connective tissue's water content decreases, and cellular regeneration slows down; acute inflammation (healing) is more likely to turn into chronic inflammation (pathology), which may cause fascial adhesion, increase fascial connective tissue stiffness and reduce its viscosity. As we do certain movements repetitively, soft tissues develop unidirectional stress, which may reduce fascia elasticity; the worst scenario—material failure happens, which we also call soft tissue injury. Other events, such as infection, trauma, selective surgeries, may all contribute to fascia adhesion/scar tissue, and alter fascia natural mechanical properties. The biological process (chronic inflammation, fascia adhesion, scar tissue) leads to the change of mechanical property, and may cause fascia connective tissue to reduce its function of support/shock absorb/protection, and lead to pathology/dysfunction. On a cellular level, chronic inflammation/fascia adhesion/scar tissue may impinge peripheral nerves travelling through fascia connective tissue, fire nociceptors causing noxious pain sensation, restrict capillary blood vessels causing reduction of blood supply and/or venous return. These biological processes may also be contributing factors for peripheral neuropathy, chronic soft tissue pain, tendonitis, fibromyalgia, myofascial pain, decreased joint range of motion post-surgery, decreasing athletic performance, and common neural diagnostic symptoms such as multiple sclerosis, cerebral palsy, Parkinson's, ALS.

Health practitioners, and movement science experts are able to utilize evidence based fascial science for fascia restriction releasing and fascia mechanical property restoration to decrease soft tissue pathological symptoms and achieve health wellness benefits. Current fascia restoration and restriction releasing techniques include but not limited to cupping, graston tool, stretching exercises, manual technique. However, the skin (The term “skin” may include multiple layers, e.g., the epidermis, the dermis, and others, as known in the art) has a greater elasticity and rigidity than fascia, which provides a phenomenon of shock absorption during current topical fascial release techniques (U.S. Pat. No. 9,649,244B1). Stretching exercises alone are effective for reducing muscle tightness/shortening, but not effective enough for localized scar tissue due to muscles' greater stiffness and less viscosity. Inventor is also a doctor in physical therapy with years of expertise in dry-needling, which is also known as “trigger point dry needling”. It is a technique applying either solid filiform needles or hollow-core hypodermic needles for therapy of muscle pain, including pain related to myofascial trigger points, but it is also used to target connective tissue, neural ailments, and muscular ailments. The American Physical Therapy Association defines dry needling as a technique used to treat dysfunction of skeletal muscle and connective tissue, minimize peripheral nociception (pain), and improve or regulate structural or functional damage. In an urgent time of pain epidemic and opioids crisis, holistic approach to pain relief has been desperately needed ever before. This invention applies a novel filiform fascia needling technique to directly manipulate connective tissue fascia to reduce fascia adhesion/restriction, restore fascia optimal mechanical property, and achieve health/wellness benefits.

### SUMMARY

This prior art reference is directed to a method for achieving myofascial adhesion release in a patient, the method including steps of penetrating an external skin of the patient with a filiform needle, moving the filiform needle horizontally through a fascia tissue layer of the patient until reaching/adjacent to a targeted fascia restriction, performing a sweeping motion to stretch connective fascia tissue within a sector area of the fascia tissue layer, performing a horizontal sweeping motion to stretch connective fascia tissue within a rectangle area of the fascia tissue layer, performing a circular/swirling motion to stretch connective fascia tissue within the targeted fascia restriction, performing a vibrating maneuver manually or performing a vibrating maneuver with a vibrating mechanism in a handle of the filiform needle, performing adjacent joint active range motion or passive range of motion during fascia needling, refrigerating the filiform needle, utilizing a second device attached to the filiform needle to increase needle inserting speed and reduce pain sensation during penetrating the external skin.

This prior art reference is directed to a method for achieving myofascial adhesion release in a patient, the method including steps of penetrating a skin of the patient with a filiform needle having a needle shaft and a handle, whereby the needle shaft with an inner layer and outer layer, moving the filiform needle through a fascia tissue layer of the patient until reaching a targeted fascia restriction, performing a sweeping motion with adjacent joint active range of motion or passive range of motion to stretch connective fascia tissue within a sector area of the fascia tissue layer, performing a horizontal sweeping motion with adjacent joint active range of motion or passive range of motion to stretch connective fascia tissue within a rectangle area of the fascia tissue layer, performing a circular/swirling motion with adjacent joint active range of motion or passive range of motion to stretch connective fascia tissue within the targeted fascia restriction, performing a vibrating maneuver manually or inserting a vibrating mechanism into a cavity in the handle, and performing a vibrating maneuver with the filiform needle with adjacent joint active range of motion or passive range of motion to stretch connective fascia tissue within the targeted fascia restriction.

This prior art reference is directed to a system for achieving myofascial adhesion release in a patient, the system including a filiform needle with a needle shaft and a handle, whereby the handle has an open cavity at an end opposite of the needle shaft, whereby a removable vibrating mechanism is positioned in the handle, whereby the needle shaft with an inner layer and outer layer, whereby the needle shaft whereby the inner layer is made of steel and the outer layer is made of a biocompatible material.

### BRIEF DESCRIPTION OF THE DRAWINGS

Embodiments of the present disclosure are described in detail below with reference to the following drawings. These and other features, aspects, and advantages of the present disclosure will become better understood with regard to the following description, appended claims, and accompanying drawings. The drawings described herein are for illustrative purposes only of selected embodiments and not all possible implementations and are not intended to limit the scope of the present disclosure.

FIG. 1 is a perspective view of a filiform needle

FIG. 2 is a topical elevational view of the filiform needle of FIG. 1

FIG. 3 shows a cross-sectional detailed view taken along the line 1-1, 2-2, and 3-3 of the filiform needle shown in FIG. 2

FIG. 4 is a side elevational view of a filiform needle inserting position.

FIG. 5 is a side elevational view of a filiform needle positioning in targeted tissue layer.

FIG. 6 is a top plan view of a first technique used for the filiform needle that has been inserted into restricted fascia layer.

FIG. 7 is a top plan view of a second technique used for the filiform needle that has been inserted into restricted fascia layer.

FIG. 8 is a top plan view of a third technique used for the filiform needle that has been inserted into restricted fascia layer.

FIG. 9 is a top plan view of a fourth technique used for the filiform needle that has been inserted into restricted fascia layer.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises”, and grammatical equivalents thereof are used herein to mean that other components, ingredients, steps, among others, are optionally present. For example, an article “comprising” (or “which comprises”) components A, B, and C can consist of (i.e., contain only) components A, B, and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and upper limit is the second number. For example, 25 to 100 mm means a range whose lower limit is 25 mm and upper limit is 100 mm.

Certain terminology and derivations thereof may be used in the following description for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The present description is directed to a system and method for achieving myofascial adhesion release in a patient via filiform fascia needling device directly manipulating the restricted fascia connective tissue and will typically be performed by licensed health care practitioners (MD, DO, NP, PT, AP) who have received adequate anatomy education and granted the privilege to perform dry-needling for this technique.

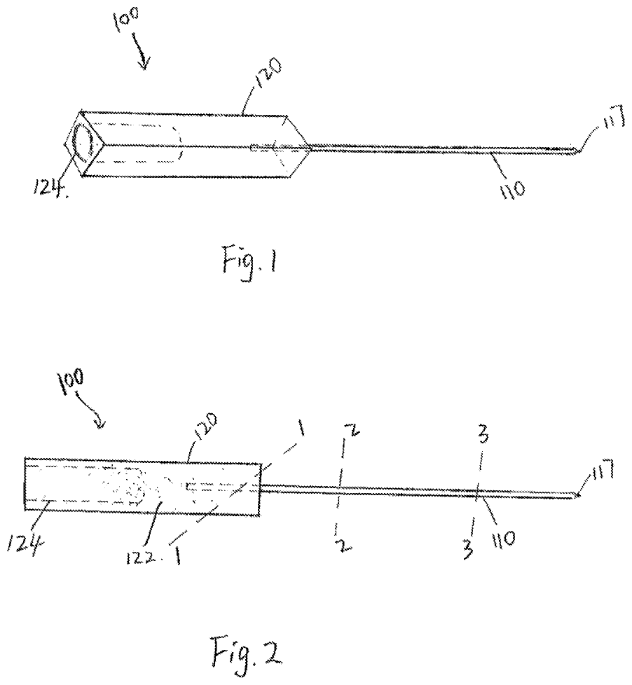

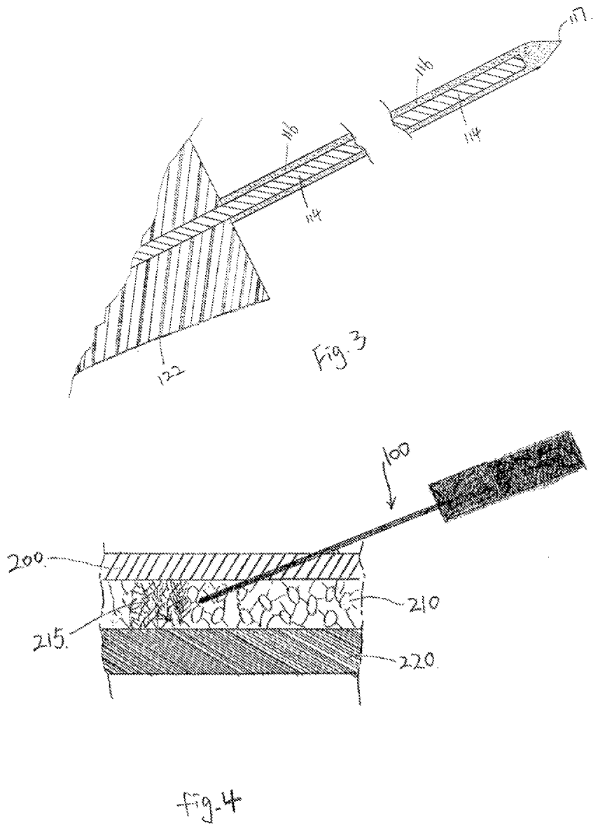

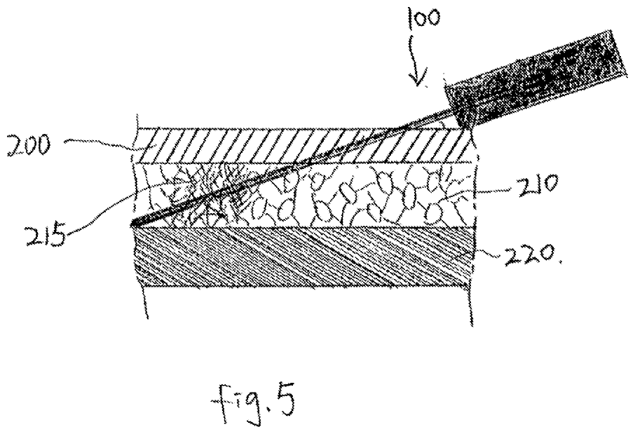

A filiform needle such as device 100 embodying features of the present invention will now be described in reference to the accompanying drawings. FIGS. 1, 2 and 3 show a perspective view, a topical elevational view, and a detailed cross-sectional view, respectively, of the filiform fascia needle device 100. Device 100 may be manufactured from any material that exhibits the strength, flexibility, and stability to sterilization appropriate for dry-needling filiform needles. Device 100 may be manufactured from any material that exhibits the strength, flexibility, and stability to sterilization appropriate for dry-needling filiform needles.

Device 100 includes a needle shaft 110 which has an inner core 114 and an outer layer 116 surrounding inner core 114, as well as a handle 120 connecting to needle shaft 110. Inner core 114 may be composed of material with great stiffness not limited to stainless steel, Flexon®, plastic, or any other material which provides structure support performing the claimed maneuvers in this invention. Outer layer 116 may be composed of preferably a biocompatible material that causes minimal trauma to the fascia connective tissue during the described maneuvers. The biocompatible material suitable for outer layer 116 includes but not limited to epoxy resins, polyurethanes, polytetrafluoroethylene, silicone, and the like, and combinations thereof. A presently desirable thermoplastic polyurethane under tradename ESTANE TPU® is sold by The Lubrizol Corporation (Wickliffe, Ohio). ESTANE TPU is temperature sensitive. As a needle tip 117 material, the rigidity increase for example at 32 Fahrenheit with refrigeration to facilitate easier needle insertion, and the rigidity decreases in human body temperature around 97.8 Fahrenheit to eliminate soft tissue trauma during fascia needle maneuver in fascia layer 210.

Handle 120 may be rectangle, however this is non-limiting and may be any suitable shape such as cylindrical or a triangular prism. Handle 120 may have arc indentation surface 122 for finger gripping placement when positioning device 100. Handle 120 may have an open cavity or hollow cylinder 124 positioned at an end opposite of needle shaft 110. Hollow cylinder 124 may act as a cavity to receive a removable vibrating device 300 which will be discussed later in the specification.

All manner of designs and shapes (e.g., conical, cylindrical, beveled, etc.) are contemplated for use in accordance with point 117 of device 100. Preferably, point 117 is conical (e.g., as is the tip of the needle portion of a safety pin) in order to facilitate penetration of the skin. However, the symmetrical V-shaped conical tip pattern illustrated in FIGS. 1, 2 and 3 is to be regarded as strictly illustrative with numerous other symmetrical and unsymmetrical designs being similarly useful. Device 100 may also be inserted by a mechanical device to increase inserting speed and reduce pain sensation during penetrating the skin 200. Refrigeration of needle device 100 preferably not limited to a temperature lower than 32 Fahrenheit prior to needle insertion may be another mean to increase point 117 rigidity and improve inserting comfort during fascia needle insertion.

While the thickness of the outer layer 116 is not limited, it is preferred to be as thin as possible in order to provide comfort while travelling/stretching in patient's fascia connective tissue 210 without substantially increasing the gauge of the shaft 110. By way of example, it is presently desirable that the thickness of insulator 12 be less than about 50 percent of the overall needle gauge, more desirably less than about 40 percent, more desirably less than about 30 percent, more desirably less than about 20 percent, and more desirably less than about 10 percent.

All manner of lengths and gauges are contemplated for use in accordance with device 100. Due to complex of two layered shaft design and higher requirement of inner layer 114 stiffness to achieve efficiency of fascia needling maneuvers. The length and gauge are preferably not limited to 1.0″/30 (0.30 mm), and 1.0″/30 (0.30 mm) respectively for distal body part and proximal body parts respectively.

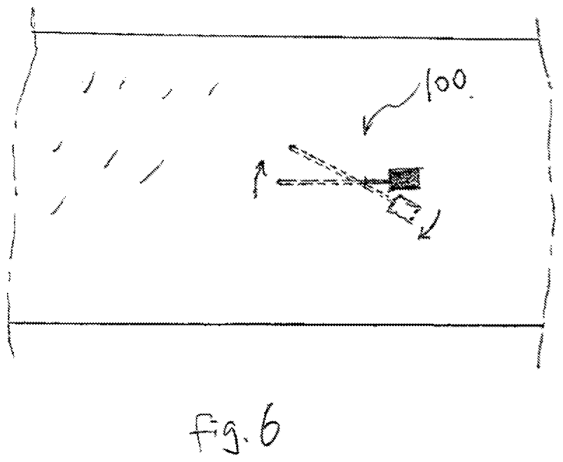

In operation, device 100 may be horizontally inserted adjacent to the restricted connective fascia tissue, as illustrated in FIG. 4. Device 100 may penetrate skin 200 at an acute angle such that device 100 horizontally travels, generally horizontally travels, or at a very narrow angle (<10 degrees) within fascia tissue layer 210 positioned above a muscle layer 220 to reach fascia restriction or adhesion 215. Practitioner may use their non-dominant hand to palpate/ping/stabilize point 117 on skin 200 to facilitate a more precise insertion location. The final insertion position may depend on device 100 length where device 100 may be positioned adjacent to the targeted fascia restriction 215, or travel through fascia restriction 215. FIG. 5 illustrates one example of a final insertion position of device 100.

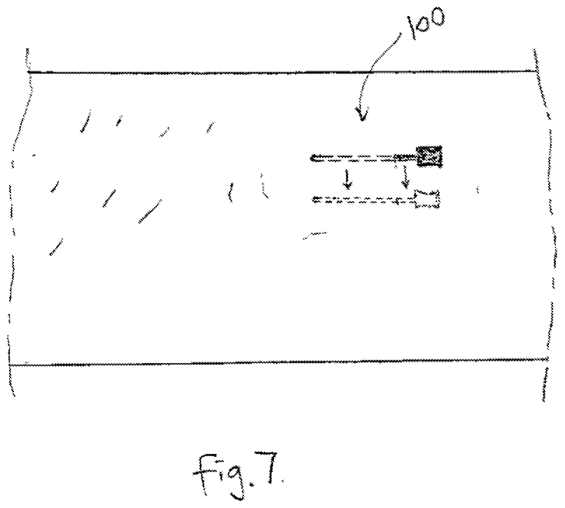

Once device 100 is inserted to the targeted position such as fascia restriction 215, a variety of techniques may be utilized. For example, as illustrated in FIG. 6, a practitioner may hold handle 120 of device 100 and perform a sweeping motion to stretch connective fascia tissue within a sector area of fascia tissue layer 210. The maneuvering time may vary depending on the degree of fascia adhesion/restriction. The maneuvering may also be performed with adjacent joint active range of motion (AROM) and/or passive range of motion (PROM) to achieve a broader and more efficient fascia stretching outcome.

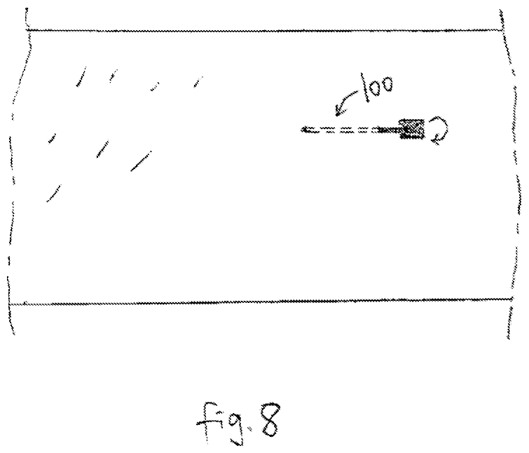

A second technique is illustrated in FIG. 7 whereby a practitioner may hold handle 120 of device 100 and perform a horizontal sweeping motion to stretch connective fascia tissue 210 within a rectangle area of fascia tissue layer 210. The maneuvering time may vary depending on the degree of fascia adhesion/restriction. The maneuvering may also be performed with adjacent joint AROM and/or PROM.

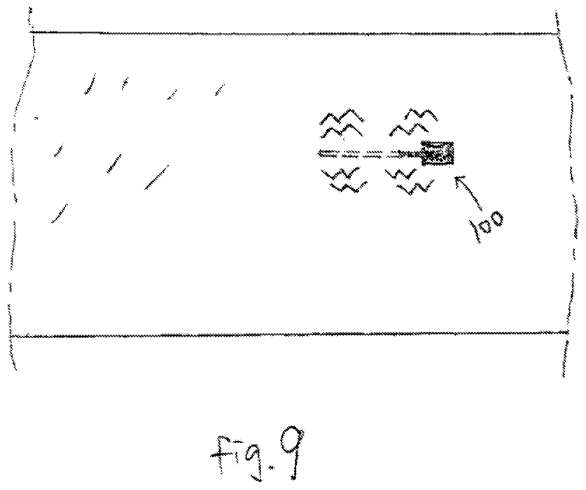

A third technique is illustrated in FIG. 8 whereby a practitioner may hold handle 120 of device 100 and perform a circular/swirling motion to stretch fascia tissue layer 210 within targeted fascia restriction 215. The maneuvering time may variate depending on the degree of fascia adhesion/restriction; the maneuvering may also be performed with adjacent joint AROM and/or PROM.

Technique 1, 2, and 3 respectively or combination provide direct fascia connective tissue stretch that is more efficient compared to traditional mechanical/manual topical technique at release fascia restriction 215. In releasing fascia restriction 215, it helps restore fascia connective tissue collagen and/or elastin protein fiber elasticity to improve fascia functional flexibility for better muscle contraction adaption. In releasing fascia restriction 215, it also may release peripheral nerve entrapment, reduce nociceptive pain signal production, remove blood capillary vessels restriction and increase blood flow to promote healing.

A fourth technique is illustrated in FIG. 9 whereby a practitioner may hold handle 120 of device 100 and perform a vibrating maneuver which may be done manually by practitioner's finger prick needle handle 120. In further embodiments a vibrating device 300 may be attached to handle 120 by inserting into hollow cylinder 124, or another part of device 100. The mechanical vibration may be constant set frequency or intermittent with variable frequency. Vibrating device 300 may have one or more motors including an electric motor with an unbalanced mass on its driveshaft. Mechanical vibration may help reduce unidirectional stress built in fascia protein fibers, improve ground substance molecular diffusion, and restore fascia viscosity. Vibrating device 300 may be secured within hollow cylinder 124 by any number of removable fasteners such as latches or hinges. In some embodiments vibrating device 300 may be inserted into hollow cylinder 124 and a lid may be connected to hollow cylinder 124 to secure and surround vibrating device 300.

This interventional method provides direct fascia stretch and fascia vibration to release fascia adhesion/restriction in chronic inflammation, reduce scar tissue restriction post trauma/surgery, and restore fascia mechanical properties. Chronic inflammation/fascia adhesion/scar tissue may impinge peripheral nerves travelling through fascia connective tissue, fire nociceptors causing noxious pain sensation, restrict capillary blood vessels causing reduction of blood supply and/or venous return. These bio-pathological processes may be reversed or reduced by efficiently release/reduce fascia restriction with this novel fascia needling method. The present invention therefore may relief symptoms related to complex regional pain syndrome, peripheral neuropathy, chronic soft tissue pain, tendonitis, fibromyalgia, myofascial pain, decreased joint range of motion post-surgery, and common neural diagnostic symptoms such as multiple sclerosis, cerebral palsy, Parkinson's, ALS. By restoring fascia optimal elasticity and viscosity, the plasticity of fascia connective tissue may also improve, which is a key element for peak athletic performance.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

What is claimed is:

1. A method for achieving myofascial adhesion release in a patient, the method comprising steps of:
penetrating an external skin of the patient with a filiform needle; and
moving the filiform needle horizontally through a fascia tissue layer of the patient until reaching/adjacent to a targeted fascia restriction.

2. The method of claim 1 further comprising:
performing a sweeping motion to stretch connective fascia tissue within a sector area of the fascia tissue layer.

3. The method of claim 1 further comprising:
performing a horizontal sweeping motion to stretch connective fascia tissue within a rectangle area of the fascia tissue layer.

4. The method of claim 1 further comprising:
performing a circular/swirling motion to stretch connective fascia tissue within the targeted fascia restriction.

5. The method of claim 1 further comprising:
performing a vibrating maneuver manually.

6. The method of claim 1 further comprising:
performing a vibrating maneuver with a vibrating mechanism in a handle of the filiform needle.

7. The method of claim 1 further comprising:
performing adjacent joint active range motion or passive range of motion during fascia needling.

8. The method of claim 1 further comprising:
refrigerating the filiform needle.

9. The method of claim 1 further comprising:
utilizing a second device attached to the filiform needle to increase needle inserting speed and reduce pain sensation during penetrating the external skin.

10. A method for achieving myofascial adhesion release in a patient, the method comprising steps of:
penetrating a skin of the patient with a filiform needle having a needle shaft and a handle, wherein the needle shaft has an inner layer and outer layer; and
moving the filiform needle through a fascia tissue layer of the patient until reaching a targeted fascia restriction.

11. The method of claim 10 further comprising:
performing a sweeping motion with adjacent joint active range of motion or passive range of motion to stretch connective fascia tissue within a sector area of the fascia tissue layer.

12. The method of claim 10 further comprising:
performing a horizontal sweeping motion with adjacent joint active range of motion or passive range of motion to stretch connective fascia tissue within a rectangle area of the fascia tissue layer.

13. The method of claim 10 further comprising:
performing a circular/swirling motion with adjacent joint active range of motion or passive range of motion to stretch connective fascia tissue within the targeted fascia restriction.

14. The method of claim 10 further comprising:
performing a vibrating maneuver manually.

15. The method of claim 10 further comprising:
inserting a vibrating mechanism into a cavity in the handle; and
performing a vibrating maneuver with the filiform needle with adjacent joint active range of motion or passive range of motion to stretch connective fascia tissue within the targeted fascia restriction.

16. A system for achieving myofascial adhesion release in a patient, the system comprising a filiform needle with a needle shaft and a handle, wherein the needle shaft has an inner layer and outer layer.

17. The system of claim 16, wherein the handle has an open cavity at an end opposite of the needle shaft.

18. The system of claim 17, wherein a removable vibrating mechanism is positioned in the handle.

19. The system of claim 18, wherein the needle shaft wherein the inner layer is made of steel and the outer layer is made of a biocompatible material.

20. The system of claim 18, wherein the biocompatible material is ESTANE TPU.
